(19) United States
(12) Patent Application Publication
(10) Pub. No.: US 2005/0208988 A1
(43) Pub. Date: Sep. 22, 2005

(54) Gaming or amusement machines and methods

(75) Inventor: Alan Geoffrey Parker, South Glamorgan (GB)

Correspondence Address: YOUNG & THOMPSON, 745 SOUTH 23RD STREET, 2ND FLOOR, ARLINGTON, VA, 22202, US

(73) Assignee: GAMESOFT LIMITED, CARDIFF (GB)

(21) Appl. No.: 10/864,383

(22) Filed: Jun. 10, 2004

Related U.S. Application Data
(60) Provisional application No. 60/477,320, filed on Jun. 11, 2003.

(51) Int. Cl. A63F 13/00

(52) U.S. Cl. 463/13; 463/20

(57) ABSTRACT

Gaming apparatus and a method of playing a game including steps of: presenting a combination of symbols generated in an at least apparently random manner; determining whether the combination results in a win state or a lose state; modifying a value in at least one win store upon a win state, and applying a modified pay out schedule for a win state resulting from at least one subsequent symbol generation step if at least one of the win stores contains a target value.

The present invention relates to gaming or amusement machines and methods.

There is a continuous search for ways and means of offering a player what to outward appearances is a better chance of a large win. However, there is always the constraint that over a period the total winnings should not outrun the input to a machine, and pay out schedules are calculated accordingly. It is also desirable to manufacturers of gaming machines to keep the player using the machine as long as possible.

According to a first aspect of the present invention there is provided a method of playing a game including steps of:

presenting a combination of symbols generated in an at least apparently random manner;

determining whether the combination results in a win state or a lose state;

modifying a value in at least one win store upon a win state, and

applying a modified pay out schedule for a win state resulting from at least one subsequent symbol generation step if at least one of the win stores contains a target value.

The win store may be a counter that is incremented by one when a win state is achieved. Thus, a player can achieve higher payouts after achieving a certain number of wins. Alternatively or additionally, the method can include a step of resetting all or some of the win counters to zero if the combination results in a lose state. This means that at least some target values can only be reached by achieving a number of consecutive wins.

The method may further include a step of resetting the counter to zero when its target value is reached. A modified pay out schedule may pay out multiples, e.g. double, of at least some of the values of a normal pay out schedule. The method may further include a step of checking an amount staked by the player and only performing the steps of modifying the win stores and applying the modified pay out schedule if the amount is a maximum amount.

There may be a plurality of independent win stores, each one being associated with different win states, such as types of winning Poker hands (e.g. Four of a Kind, Flushes). The step of modifying a value in a said win store may only be performed for certain win states. Each independent win store may be a win counter that is incremented when its associated win state is achieved. Each such win counter may be associated with a particular target value and a modified pay out schedule can be made available when one or more of the win counters reach their associated targets. Different modified pay out schedules may be associated with different win counters.

The method may further include a step of presenting a display representing at least one win store. The display may be in the form of a plurality of symbols, such as arrows, the symbols being shown corresponding to the value of the win counter. The display may include an indication that the win counter has reached its target value.

In one embodiment, the display representing the win stores may be in the form of an arrangement of symbols, such as a matrix, with the symbols typically including ones that can appear in the combination of symbols. If a win state is achieved then one or more matrix symbols corresponding to one or more respective symbols appearing in the winning combination are set to an on state (which can be considered as the target value for that win store). The modified pay out schedule may be applied when symbols forming a horizontal, vertical or diagonal line in the matrix are all set to an on state. The modified pay out schedule may take the form of making an award (e.g. a number of points) available to the player. Alternatively or additionally, the award may be made available when all the symbols in the matrix are set to an on state. The player may be able to elect whether or not to take the award immediately after it is made available. At least some of the matrix symbols may be switched to an off state when the award is paid out, typically the symbols that made the award available.

The game may be a Poker game, with the symbols being those of playing cards and each combination being a Poker hand. In this case, the step of determining whether a combination of cards results in a win state or a lose state may be made in accordance with substantially conventional Poker rules.

According to a second aspect of the present invention there is provided a method of playing a game including steps of;

presenting a combination of symbols generated in an at least apparently random manner;

determining whether the combination results in a win state or a lose state;

modifying a value in at least one win store upon a lose state, and

applying a modified pay out schedule for a win state resulting from at least one subsequent symbol generation step if at least one of the win stores contains a target value.

An embodiment of such a game can allow a player to apply more strategy to his gameplay. For example, if the target value is reached upon ten non-winning games and a player has had seven losing games then he may deliberately lose three further games to reach the target if it results in a bigger pay out. This gives the player an enhanced feeling of control and encourages him to continue playing.

According to a further aspect of the present invention there is provided a gaming or amusement apparatus configured to execute a method substantially as described above. According to another aspect of the present invention there is provided a gaming or amusement apparatus including: a device for presenting a combination of symbols generated in an at least apparently random manner;

a device for determining whether the combination results in a win state or a lose state;

a device for modifying a value in at least one win store upon a win state, and

a device for applying a modified pay out schedule for a win state resulting from at least one subsequent symbol generation step if at least one of the win stores contains a target value.

Whilst the invention has been described above, it extends to any inventive combination of the features set out above or in the following description.

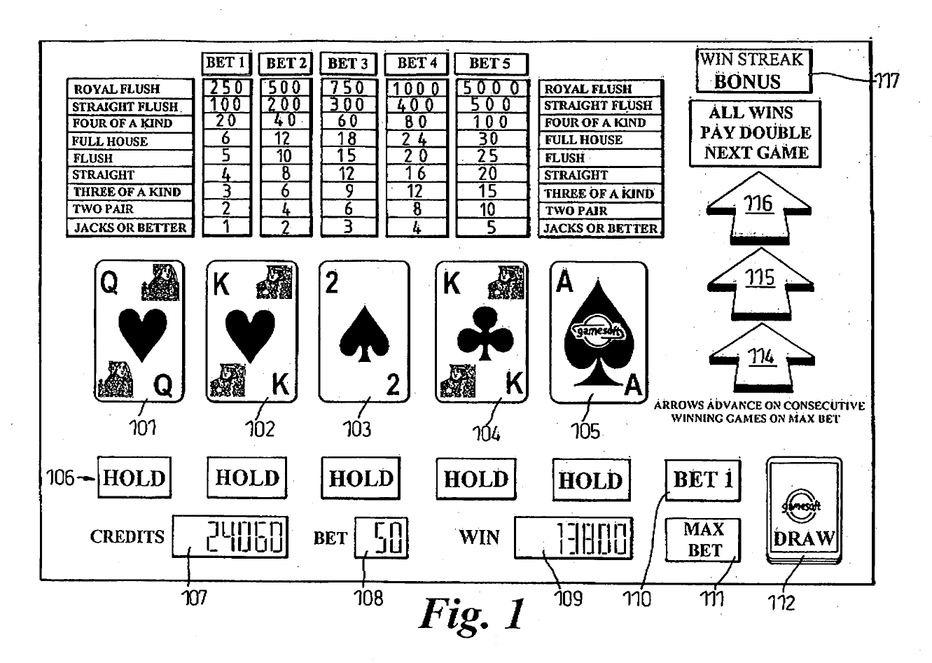

The invention may be performed in various ways, and, by way of example only, an embodiment thereof will now be described, reference being made to the accompanying drawings, in which FIGS. 1 to 5 illustrate displays produced by five different embodiments of the game.

Referring to FIG. 1, the screen display of the first embodiment contains several elements which are common to existing video poker games. A simulated poker hand is dealt to the player with the cards being shown at locations 101 to 105. The display also includes five touch screen Hold buttons 106, each corresponding to one of the cards 101 to 105. Credits (the total credits playable) 107, Bet (the number of credits staked on the current hand) 108 and Win (the total points scored by the player) 109 displays are also included. Further touch screen buttons include a Bet 1 (i.e. increase number of credits staked on the current hand by one) button 110, a Max Bet (i.e. stake 5 credits) button 111 and a Draw button 112. Operation of these elements is well known to those skilled in the art. Descriptions of elements common to all of the embodiments of FIGS. 1 to 5 will not be repeated.

The display further includes a pay table 113 which shows the amount paid out if a winning poker hand is dealt, the amount varying with the number of credits bet by the player, as shown in the columns Bet 1 to Bet 5. For example, if the player has bet three credits and is dealt a Four of a Kind hand then the number of points paid out is 60.

As well as awarding points when a winning hand is dealt, if the hand was one upon which the player placed a maximum bet then one of the arrow symbols 114 to 117 is also lit up. However, if the player is dealt a non-winning hand for a game upon which he placed the maximum stake then any of the lights 114 to 117 that are already illuminated are extinguished. Thus, the second light 115 can only be lit after a win that has already lit the arrow 114, and arrow 116 and a Winning Streak Bonus symbol 117 are only lit after three consecutive winning games upon which the maximum bet have been placed.

The Win Streak Bonus symbol 117 remains lit for subsequent games until the player is dealt a winning hand and he is then awarded double the normal number of points indicated in the pay out schedule 113 for that hand. Afterwards, all of the symbols 114 to 117 are extinguished and play continues as usual.

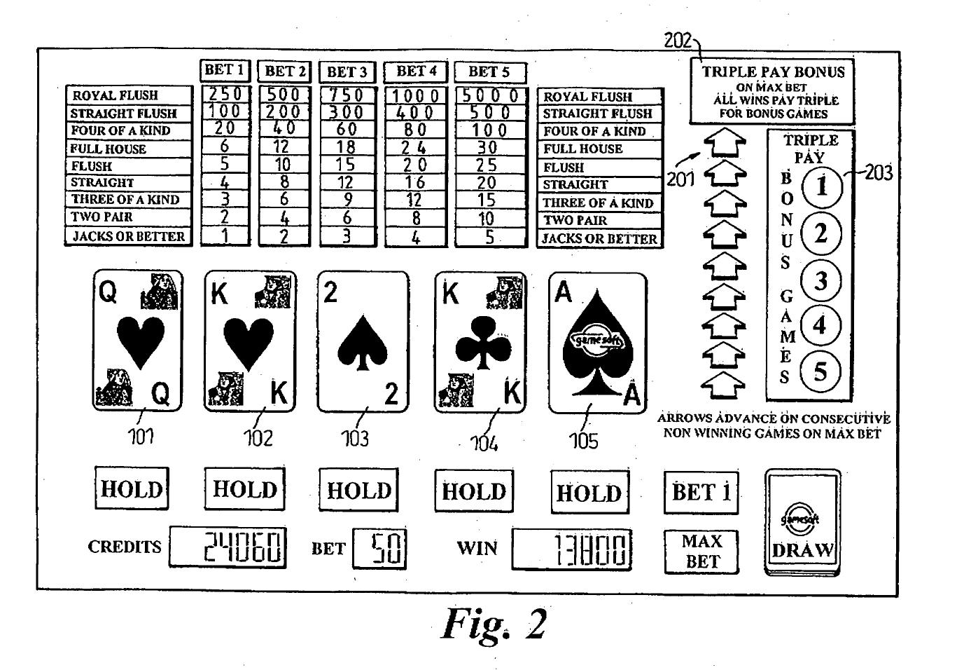

Turning to FIG. 2, the display produced by the second embodiment of the game includes a set 201 of ten arrows leading to a Triple Pay Bonus symbol 202. If a player loses a hand upon which he had placed the maximum bet then one of the arrows 201 is lit up. The next game upon which he has placed the maximum bet and lost results in the next arrow of the set 201 being lit, and so on. However, if the player wins a maximum bet game then all of the arrows 201 are switched off.

Therefore, if the player plays ten consecutive non-winning games upon which he has bet the maximum amount, all ten arrows 201 and the Triple Pay Bonus symbol 202 are lit and the value of any winning hands achieved during the five games that immediately follow are tripled. Numbers in the triple pay panel 203 are used to indicate the number of triple pay games the player has left to play. After the five games have been played, all the arrows 201A and the panels 202 and 203 are switched off and play continues.

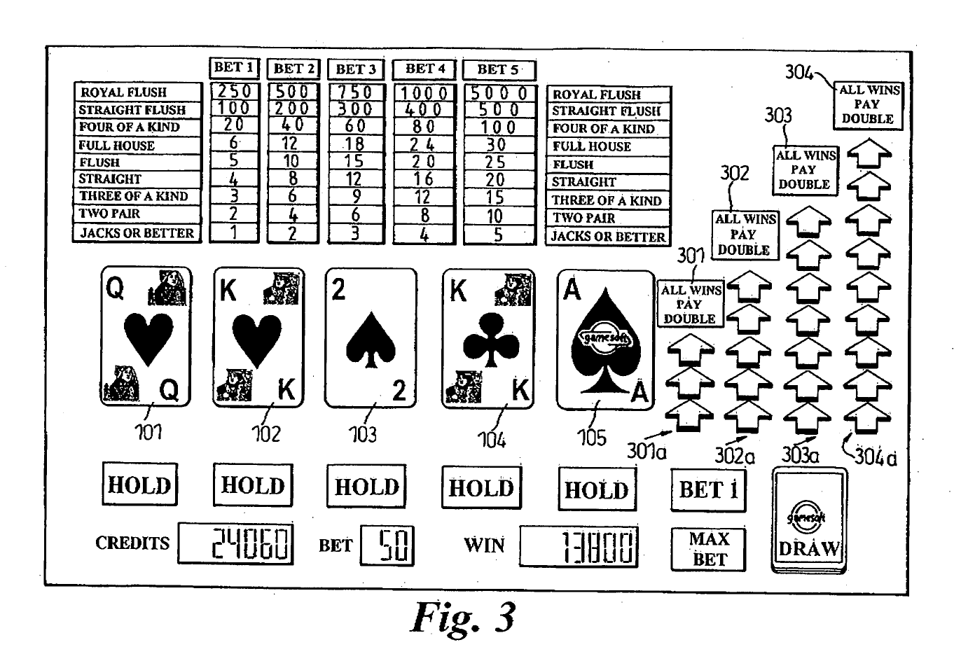

Referring to the third embodiment illustrated in FIG. 3, the game display includes a Four of a Kind Pay Double symbol 301 an associated set 301a of three arrows; an All Flushes Pay Double symbol 302 and an associated set 302a of five arrows as well as a Three of a Kind Pay Double symbol 303 and an associated set 303a of seven arrows. An All Wins Pay Double symbol 304 is also displayed, which is associated with a set 304a of nine arrows.

Each time the player is dealt a winning hand upon which he bet the maximum amount, one of the All Wins Pay Double arrows 304a is lit. If the win results from a Four of a Kind, a Flush or a Three of a Kind hand being dealt then one of the arrows from the appropriate set 301a to 303a is lit as well. Other types of winning hands will not normally result in an arrow being lit. If any of the sets of arrows 301a to 304a are fully lit then its associated panel 301 to 304 is also switched on. Whilst any one of the panels is illuminated, the player is awarded double the amount shown in the pay out schedule for the next winning game of that type. Furthermore, if the All Wins symbol 304 and one of the other symbols 301 to 303 are lit simultaneously then the pay out for the next winning game of type 301 to 303 will be four times the value shown in the pay out schedule 113. The symbols 301 to 304 (and their associated sets of arrows) are extinguished after a win has been achieved whilst they are lit.

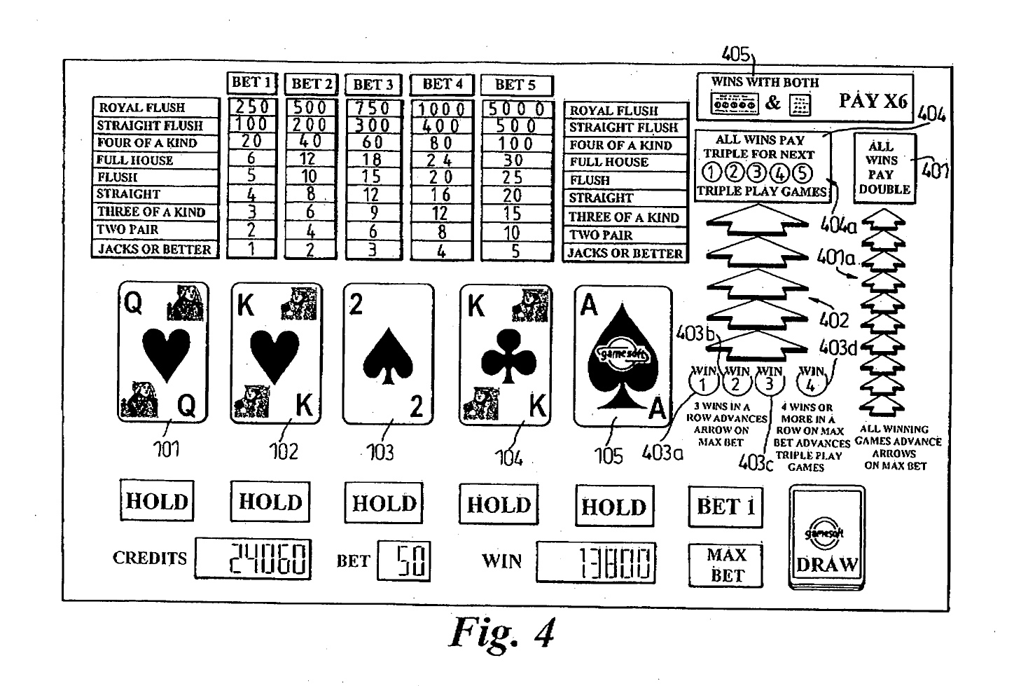

Turning to the fourth embodiment shown in FIG. 4, the game display includes an All Wins Pay Double symbol 401 which is associated with a set 401a of ten arrows. These function in a substantially identical manner to the All Wins Pay Double feature of the third embodiment described above.

The extra feature of FIG. 4 is manifested by a vertical array of five arrows 402 leading upwards from a horizontal line of four dots 403a-d, grouped three and one, to a panel 404 with five dots 404a-e in a horizontal line, the first dot 404a always being lit. Above that is a further panel 405 that is activated when both this extra feature and that associated with the arrows 401 produce prospective major wins.

When the player first achieves a winning hand on a maximum bet the first dot 403a is lit. If the next game is a win with a maximum bet, the second dot 403b is lit. A third consecutive maximum bet win lights the third dot 405c and the first arrow 402a.

If the next game is a loss, the dots 403a-c extinguish but the arrow 402a remains illuminated. A subsequent run of three consecutive maximum bet wins illuminates the dots 403a-c again and the second arrow 402b, and so on until all five arrows 402 are illuminated.

The first time the player achieves four consecutive maximum bet wins, the fourth dot 403d illuminates, and then the second dot 404b. The second time this happens, the fourth dot 403d and the third dot 404c illuminate and so On.

When the player has lit up all five arrows 402, the number of dots 404 illuminated determines the payouts for subsequent winning games. If still only the first dot 404a is lit up, just the next winning game will produce three times the normal payout. But if the fourth dot 404d, say, is illuminated, then there will be a triple payout on the next four winning games. Once those have gone, all the arrows 402 and dots 403 and 404, except first dot 404a, extinguish.

Should the complete set of arrows 401 be illuminated at the same time as the complete set of arrows 402, then the effect on subsequent payouts is multiplied as indicated by the topmost panel 405, the player receiving six times the normal prize from a win.

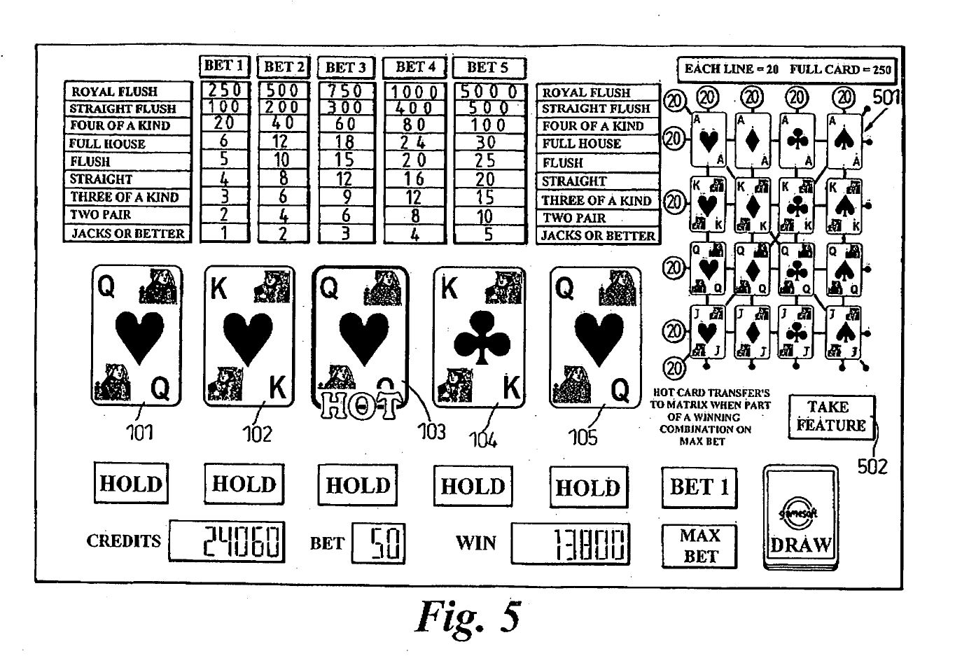

Referring to the fifth embodiment illustrated in FIG. 5, the game display includes a matrix, generally indicated at 501, which is a 4×4 array of card symbols. When a player achieves a winning hand, if there is a card in the matrix having the same symbol as the central card 103 of the five card hand then the corresponding matrix symbol is illuminated. However, it may be made necessary for the central card to be an active contribution to the winning hand. Thus, if there were two pairs and the odd card out was the central one in the display then it could be arranged that the corresponding matrix card would not be illuminated.

As play continues, more and more of the matrix cards may be lit up and when a horizontal, diagonal or vertical line (indicated by the lines between the matrix card symbols) of the matrix is illuminated then the player is given the option of taking a feature. The feature may be an award of a certain number of points. If the player wants to take the points then he touches a Take Feature button 502. This also results in the card symbols in the line which make the feature available being extinguished. If the player does not immediately elect to take the points for a line of cards then the button 502 remains activated and the player can “take” later, perhaps when another line of matrix symbols is fully lit. Advantage can be taken of having a card common to two mutually transverse lines. Pressing the Take Feature button 502 at any point will result in the player being awarded all of the points due from all of the lines which have been illuminated. The number of points offered for a winning line is 20 but if the player waits until all ten lines of the matrix cards are illuminated then he can be awarded 250 points (a bonus of 50).

1. A method of playing a game including steps of:
presenting a combination of symbols generated in an at least apparently random manner;
determining whether the combination results in a win state or a lose state;
modifying a value in at least one win store upon a win state, and
applying a modified pay out schedule for a win state resulting from at least one subsequent symbol generation step if at least one of the win stores contains a target value.

2. A method according to claim 1, wherein a said win store is a counter that is incremented by one when a win state is achieved.

3. A method according to claim 2, further including a step of resetting all or some of the win counters to zero if the combination results in a lose state.

4. A method according to claim 2, further including a step of resetting all or some of the win counters to zero when a target value is reached.

5. A method according to claim 1, wherein the modified pay out schedule pays out multiples, e.g. double, of at least some of the values of a normal pay out schedule.

6. A method according to claim 1, further including a step of checking an amount staked by the player and only performing the steps of modifying the win stores and applying the modified pay out schedule if the amount is a maximum amount.

7. A method according to claim 2, wherein each said win counter is associated with a associated target value and the modified pay out schedule is made available when one or more of the win counters reach their associated target values.

8. A method according to claim 1, further including a step of presenting a display representing at least one said win store.

9. A method according to claim 8, wherein the win store display is in the form of a plurality of symbols, such as arrows, the number of symbols being highlighted corresponding to the value of the win counter.

10. A method according to claim 8, wherein the win store display is in the form of a matrix.

11. A method according to claim 10, wherein if a said win state is achieved then one or more matrix symbols corresponding to one or more respective symbols appearing in the winning combination are set to an on state.

12. A method according to claim 11, wherein the modified pay out schedule is applied when symbols forming a horizontal, vertical or diagonal line in the matrix are all set to an on state.

13. A method according to claim 1, wherein the modified pay out schedule takes the form of making an award (e.g. a number of points) available to the player and the player is able to elect whether or not to take the award immediately after it is made available.

14. A method according to claim 1, wherein the symbols are those of playing cards and each said combination is a Poker hand, the step of determining whether a combination of cards results in a win state or a lose state being made in accordance with substantially conventional Poker rules.

15. A method of playing a game including steps of:
presenting a combination of symbols generated in an at least apparently random manner;
determining whether the combination results in a win state or a lose state;
modifying a value in at least one store upon a lose state, and
applying a modified pay out schedule for a win state resulting from at least one subsequent symbol generation step if at least one of the stores contains a target value.

16. Gaming or amusement apparatus including:
a device for presenting a combination of symbols generated in an at least apparently random manner;
a device for determining whether the combination results in a win state or a lose state;
a device for modifying a value in at least one win store upon a win state, and
a device for applying a modified pay out schedule for a win state resulting from at least one subsequent symbol generation step if at least one of the win stores contains a target value.
